(19) United States
(12) Patent Application Publication
(10) Pub. No.: US 2016/0088594 A1
(43) Pub. Date: Mar. 24, 2016

(54) DEVICE AND METHOD OF SUPPORTING REDUCED DATA TRANSMISSION BANDWIDTH

(71) Applicants: Gang Xiong, Beaverton, OR (US); Seunghee Han, Cupertino, CA (US); Jong-Kae Fwu, Sunnyvale, CA (US); Debdeep Chatterjee, Santa Clara, CA (US)

(72) Inventors: Gang Xiong, Beaverton, OR (US); Seunghee Han, Cupertino, CA (US); Jong-Kae Fwu, Sunnyvale, CA (US); Debdeep Chatterjee, Santa Clara, CA (US)

(21) Appl. No.: 14/718,750

(22) Filed: May 21, 2015

Related U.S. Application Data
(60) Provisional application No. 62/052,253, filed on Sep. 18, 2014.

(51) Int. Cl. H04W 72/04; H04L 5/00; H04W 4/00

(52) U.S. Cl. CPC H04W 72/042; H04W 72/0446; H04W 4/005; H04L 5/0007

(57) ABSTRACT

An eNodeB (eNB), user equipment (UE) and method for operating using a reduced data transmission bandwidth are generally described. The UE may receive downlink control information (DCI) that provides a resource allocation (RA) of a reduced physical resource block (PRBₘᵢₙ) of less than 1 PRB for communications in a PRB of a subframe. Whether the RA is localized or distributed may be predefined, configured via system information block or Radio Resource Control signaling, or indicated in the DCI format. The DCI format may specify the resources within the PRB allocated to the UE through a subcarrier block index and total number of subcarrier blocks or a bitmap corresponding to a unique block of subcarriers or block index. An order in a list of cell Radio Network Temporary Identifiers (RNTIs) may be used with a common RNTI to derive the reduced RA from a 1 PRB RA.

### PRIORITY CLAIM

This application claims the benefit of priority to U.S. Provisional Patent Application Ser. No. 62/052,253, filed Sep. 18, 2014, and entitled “SUPPORT FOR DATA TRANSMISSION BANDWIDTH LESS THAN 1 PRB FOR MTC UES,” which is incorporated herein by reference in its entirety.

### TECHNICAL FIELD

Embodiments pertain to wireless communications. Some embodiments relate to cellular communication networks including Third Generation Partnership Project Long Term Evolution (3GPP LTE) networks and LTE advanced (LTE-A) networks as well as 4^{th} generation (4G) networks and 5^{th} generation (5G) networks. Some embodiments relate to enhanced coverage communication.

### BACKGROUND

With the increase in different types of devices communicating over networks to servers and other computing devices, usage of third generation long term evolution (3GPP LTE) systems has increased. In particular, both normal user equipment (UE) such as cell phones and Machine Type Communications (MTC) UEs currently use 3GPP LTE system. MTC UEs pose a particular challenge due to low energy consumption involved in such communication. In particular, MTC UEs are less computationally powerful and have less power for communication, and many are configured to remain essentially indefinitely in a single location. Examples of such MTC UEs include sensors (e.g., sensing environmental conditions) or microcontrollers in appliances or vending machines. In some circumstances, the MTC UEs may be located in areas where there is little to no coverage, such as inside buildings, or in isolated geographical areas. Unfortunately, in a number of cases, MTC UEs do not have sufficient power for communications with the nearest serving base station (enhanced Node B (eNB)) with which they communicate. Similar problems may exist for non-stationary wireless UEs, such as mobile phones, that are disposed in a network area with poor coverage, i.e., one in which the link budget is several dB below typical network values.

Transmission power may not be able to be increased either by a UE or eNB in situations in which UEs are in such areas. To achieve coverage extension and obtain additional dB in link budget, signals may be repeatedly transmitted from the transmitting device (either the UE or eNB) over an extended period across multiple subframes and physical channels to accumulate energy at the receiving device (the other of the UE or eNB). In the existing LTE standard, the minimum uplink or downlink resource that may be scheduled is 1 physical resource block (PRB). The message size used by MTC UEs may be limited compared with normal UEs and use much less than 1 PRB. It may therefore be desirable to allocate resources for uplink or downlink data transmission to MTC UEs with a smaller granularity than 1 PRB.

### BRIEF DESCRIPTION OF THE FIGURES

In the figures, which are not necessarily drawn to scale, like numerals may describe similar components in different views. Like numerals having different letter suffixes may represent different instances of similar components. The figures illustrate generally, by way of example, but not by way of limitation, various embodiments discussed in the present document.

FIG. 1 is a functional diagram of a 3GPP network in accordance with some embodiments.

FIG. 2 is a block diagram of a 3GPP device in accordance with some embodiments.

FIGS. 3A and 3B illustrate downlink allocations in a subframe in accordance with some embodiments.

FIGS. 4A and 4B illustrate downlink allocations in a subframe with frequency hopping in accordance with some embodiments.

FIG. 5 illustrates a flowchart of a method of employing a reduced data transmission bandwidth in accordance with some embodiments.

### DETAILED DESCRIPTION OF THE INVENTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

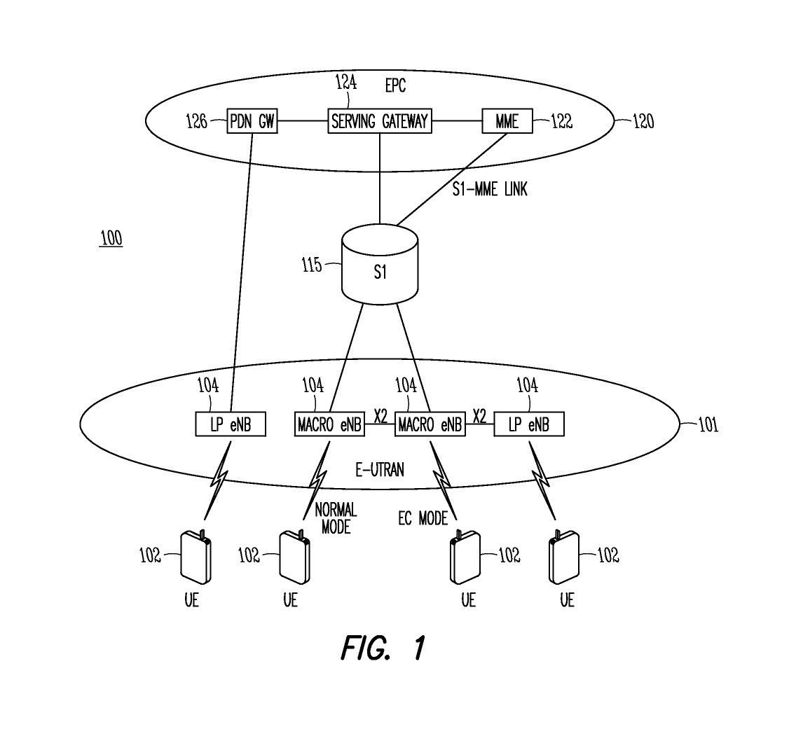

FIG. 1 is a functional diagram of a 3GPP network in accordance with some embodiments. The network may comprise a radio access network (RAN) (e.g., as depicted, the E-UTRAN or evolved universal terrestrial radio access network) 100 and the core network 120 (e.g., shown as an evolved packet core (EPC)) coupled together through an S1 interface 115. For convenience and brevity sake, only a portion of the core network 120, as well as the RAN 100, is shown.

The core network 120 includes mobility management entity (MME) 122, serving gateway (serving GW) 124, and packet data network gateway (PDN GW) 126. The RAN 100 includes Evolved Node-B's (eNBs) 104 (which may operate as base stations) for communicating with UE 102. The eNBs 104 may include macro eNBs and low power (LP) eNBs.

The MME is similar in function to the control plane of legacy Serving GPRS Support Nodes (SGSN). The MME manages mobility aspects in access such as gateway selection and tracking area list management. The serving GW 124 terminates the interface toward the RAN 100, and routes traffic packets (such as data packets or voice packets) between the RAN 100 and the core network 120. In addition, it may be a local mobility anchor point for inter-eNB handovers and also may provide an anchor for inter-3GPP mobility. Other responsibilities may include lawful intercept, charging, and some policy enforcement. The serving GW 124 and the MME 122 may be implemented in one physical node or separate physical nodes. The PDN GW 126 terminates a SGi interface toward the packet data network (PDN). The PDN GW 126 routes traffic packets between the EPC 120 and the external PDN, and may be a key node for policy enforcement and charging data collection. It may also provide an anchor point for mobility with non-LTE accesses. The external PDN can be any kind of IP network, as well as an IP Multimedia Subsystem (IMS) domain. The PDN GW 126 and the serving GW 124 may be implemented in one physical node or separated physical nodes.

The eNBs 104 (macro and micro) terminate the air interface protocol and may be the first point of contact for a UE 102. The eNBs 104 may communicate both with UEs 102 in a normal coverage mode and UEs 104 in one or more enhanced coverage modes. In some embodiments, an eNB 104 may fulfill various logical functions for the RAN 100 including but not limited to RNC (radio network controller functions) such as radio bearer management, uplink and downlink dynamic radio resource management and traffic packet scheduling, and mobility management. In accordance with embodiments, UEs 102 may be configured to communicate Orthogonal Frequency Division Multiplexing (OFDM) communication signals with an eNB 104 over a multicarrier communication channel in accordance with an OFDMA communication technique. The OFDM signals may comprise a plurality of orthogonal subcarriers. Other technologies may also be used, such as Non-Orthogonal Multiple Access (NOMA), Code Division Multiple Access (CDMA), and Orthogonal Frequency-Division Multiple Access (OFDMA).

The S1 interface 115 is the interface that separates the RAN 100 and the EPC 120. It is split into two parts: the S1-U, which carries traffic packets between the eNBs 104 and the serving GW 124, and the S1-MME, which is a signaling interface between the eNBs 104 and the MME 122.

With cellular networks, LP cells are typically used to extend coverage to indoor areas where outdoor signals do not reach well, or to add network capacity in areas with very dense phone usage, such as train stations. As used herein, the term low power (LP) eNB refers to any suitable relatively low power eNB for implementing a narrower cell (narrower than a macro cell) such as a femtocell, a picocell, or a micro cell. Femtocell eNBs are typically provided by a mobile network operator to its residential or enterprise customers. A femtocell is typically the size of a residential gateway or smaller and generally connects to the user's broadband line. Once plugged in, the femtocell connects to the mobile operator's mobile network and provides extra coverage in a range of typically 30 to 50 meters for residential femtocells. Thus, a LP eNB might be a femtocell eNB since it is coupled through the PDN GW 126. Similarly, a picocell is a wireless communication system typically covering a small area, such as in-building (offices, shopping malls, train stations, etc.), or more recently in-aircraft. A picocell eNB can generally connect through the X2 link to another eNB such as a macro eNB through its base station controller (BSC) functionality. Thus, LP eNB may be implemented with a picocell eNB since it is coupled to a macro eNB via an X2 interface. Picocell eNBs or other LP eNBs may incorporate some or all functionality of a macro eNB. In some cases, this may be referred to as an access point base station or enterprise femtocell.

Communication over an LTE network may be split up into 10 ms frames, each of which may contain ten 1 ms subframes. Each subframe of the frame, in turn, may contain two slots of 0.5 ms. Each subframe may be used for uplink (UL) communications from the UE to the eNB or downlink (DL) communications from the eNB to the UE. The eNB may allocate a greater number of DL communications than UL communications in a particular frame. The eNB may schedule uplink and downlink transmissions over a variety of frequency bands. The allocation of resources in subframes used in one frequency band and may differ from those in another frequency band. Each slot of the subframe may contain 6-7 symbols, depending on the system used. In some embodiments, the subframe may contain 12 or 24 subcarriers. A downlink resource grid may be used for downlink transmissions from an eNB to a UE, while an uplink resource grid may be used for uplink transmissions from a UE to an eNB or from a UE to another UE. The resource grid may be a time-frequency grid, which is the physical resource in each slot. The smallest time-frequency unit in a resource grid may be denoted as a resource element (RE). Each column and each row of the resource grid may correspond to one OFDM symbol and one OFDM subcarrier, respectively. The resource grid may contain resource blocks (RBs) that describe the mapping of physical channels to resource elements and physical RBs (PRBs). A PRB may be the smallest unit of resources that can be allocated to a UE in the current 3GPP standard. A resource block may be 180 kHz wide in frequency and 1 slot long in time. In frequency, resource blocks may be either 12×15 kHz subcarriers or 24×7.5 kHz subcarriers wide. For most channels and signals, 12 subcarriers may be used per resource block, dependent on the system bandwidth. The duration of the resource grid in the time domain corresponds to one subframe or two resource blocks. Each resource grid may comprise 12 (subcarriers)*14 (symbols)=168 resource elements for normal cyclic prefix (CP) case.

In addition to the physical resource block, the LTE system may also define a virtual resource block (VRB). A VRB may have a structure and a size the same as a PRB. A VRB may be of different types: distributed and localized. In resource allocation, a pair of VRBs located at two slots in a subframe may be distributed together, one pair of VRBs may have an index n_{VRB}. A localized VRB may be mapped to a PRB, i.e. n_{PRB}=n_{VRB}; in two slots in a subframe, the mappings from a localized VRB to the PRB may be the same. A distributed VRB may be mapped to the PRB according to a frequency hopping rule in which n_{PRB}=f(n_{VRB},nₛ) where nₛ=0-19 (the slot number of a radio frame). Between the slots in a subframe, mappings from a distributed VRN to the PRB may differ.

There may be several different physical channels that are conveyed using such resource blocks, including a physical downlink control channel (PDCCH) and physical downlink shared channel (PDSCH) in a downlink transmission and a physical uplink control channel (PUCCH) and physical uplink shared channel (PUSCH) in an uplink transmission. Each downlink subframe may be partitioned into the PDCCH and PDSCH while each uplink subframe may contain a PUCCH and PUSCH. The PDCCH may normally occupy the first two symbols of each subframe and carry, among other things, information about the transport format and resource allocations related to the PDCCH, as well as H-ARQ information related to the uplink or downlink shared channel. The PDSCH or PUSCH may carry user data and higher layer signaling to the UE or eNB and occupy the remainder of the subframe.

Typically, downlink scheduling (assigning control and shared channel resource blocks to UEs within a cell) may be performed at the eNB based on channel quality information provided from the UEs to the eNB, and then the downlink resource assignment information may be sent to each UE on the PDCCH assigned to the UE. The PDCCH may contain downlink control information (DCI) in one of a number of formats that tell the UE how to find and decode data, transmitted on PDSCH in the same subframe, from the resource grid. Thus, the UE may receive downlink transmissions, detect a PDCCH, and decode the DCI based on the PDCCH before decoding the PDSCH. The DCI format may provide details such as number of resource blocks, resource allocation type, modulation scheme, transport block, redundancy version, coding rate etc. Each DCI format may have a 16 bit cyclic redundancy code (CRC) and be scrambled with a Radio Network Temporary Identifier (RNTI) that identifies the target UE for which the PDSCH is intended. Use of the UE-specific RNTI may limit decoding of the DCI format (and hence the corresponding PDSCH) to only the intended UE.

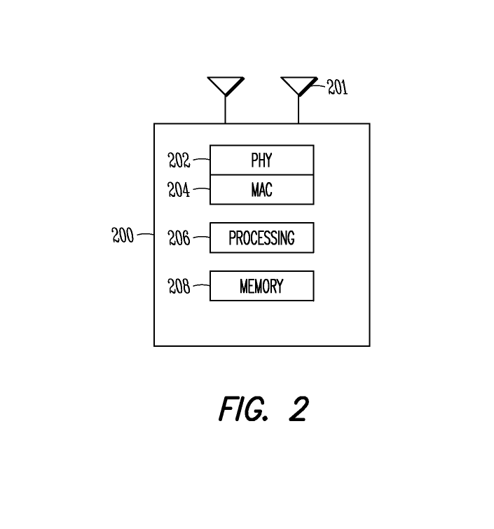

FIG. 2 is a functional diagram of a 3GPP device in accordance with some embodiments. The device may be a UE or eNB, for example. In some embodiments, the eNB may be a stationary non-mobile device. The 3GPP device 200 may include physical layer circuitry 202 for transmitting and receiving signals using one or more antennas 201. The 3GPP device 200 may also include medium access control layer (MAC) circuitry 204 for controlling access to the wireless medium. The 3GPP device 200 may also include processing circuitry 206 and memory 208 arranged to perform the operations described herein.

In some embodiments, mobile devices or other devices described herein may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), or other device that may receive and/or transmit information wirelessly. In some embodiments, the mobile device or other device can be a UE 102 or eNB 104 configured to operate in accordance with 3GPP standards. In some embodiments, the mobile device or other device may be configured to operate according to other protocols or standards, including IEEE 802.11 or other IEEE standards. In some embodiments, the mobile device or other device may include one or more of a keyboard, a display, a non-volatile memory port, multiple antennas, a graphics processor, an application processor, speakers, and other mobile device elements. The display may be an LCD screen including a touch screen.

The antennas 201 may comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas 201 may be effectively separated to take advantage of spatial diversity and the different channel characteristics that may result.

Although the 3GPP device 200 is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

Embodiments may be implemented in one or a combination of hardware, firmware and software. Embodiments may also be implemented as instructions stored on a computer-readable storage device, which may be read and executed by at least one processor to perform the operations described herein. A computer-readable storage device may include any non-transitory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. Some embodiments may include one or more processors and may be configured with instructions stored on a computer-readable storage device.

The term “machine readable medium” may include a single medium or multiple media (e.g., a centralized or distributed database, and/or associated caches and servers) configured to store one or more instructions. The term “machine readable medium” may include any medium that is capable of storing, encoding, or carrying instructions for execution by the 3GPPP device 200 and that cause it to perform any one or more of the techniques of the present disclosure, or that is capable of storing, encoding or carrying data structures used by or associated with such instructions. The term “transmission medium” shall be taken to include any intangible medium that is capable of storing, encoding or carrying instructions for execution, and includes digital or analog communications signals or other intangible medium to facilitate communication of such software.

As described above, the minimum scheduling granularity of the current 3GPP standard is 1 PRB. In some embodiments, the granularity may be reduced to provide a smaller effective PRB (hereinafter referred to as PRBₘᵢₙ). The PRBₘᵢₙ may be limited in frequency and/or time. Resources of less than 1 PRB, similar to resources of 1 PRB, may be allocated to the UE, thereby permitting the UE to communicate with the eNB using the smaller set of resources. In some embodiments, allocation information may be provided in control signaling prior to the UE receiving a PDCCH signal. Allocation of the PRB into PRBₘᵢₙ components may, in some embodiments, be explicitly indicated in the DCI for downlink assignment or uplink grant. The DCI may indicate which resource block carries the data and the demodulation scheme to be used to decode data among others. The receiver may first use blind decoding to decode the DCI and, based on the information in the DCI, decode the data (contained in the PDSCH for downlink transmissions and the PUSCH for uplink transmissions). The reduced PRB may permit MTC UEs to transmit messages of the reduced size used by MTC UEs (compared with normal UEs) and apply increased or maximum transmit power on the smaller bandwidth in uplink transmissions, thereby improving power spectral density (PSD) to enhance coverage for the MTC UE.

There are a number of DCI formats that may presently exist in TS 36.212, which may differ between uplink and downlink transmissions. Downlink DCI formats may include format 1, 1A, 1B, 1C, 1D, 2 and 2A and uplink DCI formats such as format 0, 3 and 3A. Formats 1, 1A, 1B, 1C and 1D may be used to schedule a PDSCH codeword for either single-input-single-output (SISO) or MIMO applications, while formats 2 and 2A may be used to schedule the PDSCH in using different multiplexing. Format 0 may be used to schedule uplink data (on a PUSCH), while formats 3 and 3A may be used to indicate uplink transmit power control. The DCI formats, whether used for uplink or downlink, may each include a plurality of fields. The fields may include the resource allocation header, resource block assignment, modulation and coding scheme, HARQ process number, new data indicator, redundancy version, transmit power control (TPC) command, and downlink assignment index (DAI). The resource allocation header may indicate the type of resource allocation used for PDSCH/PUSCH resource mapping. There may be two bit map-based resource allocation types (type0 and type1), where each bit addresses a single or group of resource blocks. The resource block assignment may be used by the UE to interpret the resource allocation of PDSCH on type0 or type1 allocation. The resource block assignment may include the number of resource allocation bits and, depending on the allocation type and bandwidth, other information used for allocation and indication. The modulation and coding scheme field may indicate the coding rate and the modulation scheme used to encode the PDSCH codeword. The modulation schemes currently supported may be QPSK, 16QAM & 64QAM. The HARQ process number field may indicate the HARQ process number used by the higher layers for the current PDSCH codeword. The HARQ process number may be associated with the New Data Indicator and Redundancy Version field. The new data indicator may indicate whether the codeword is a new transmission or a re-transmission. The redundancy version may indicate the redundancy version of the codeword, which may specify the amount of redundancy, of 4 different versions corresponding to new transmission, added into the codeword while turbo encoding. The TPC command may specify the power for to the UE to use in transmitting a PUCCH. The DAI is a TDD-specific field that may indicate the counts of downlink assignments scheduled for the UE within a subframe.

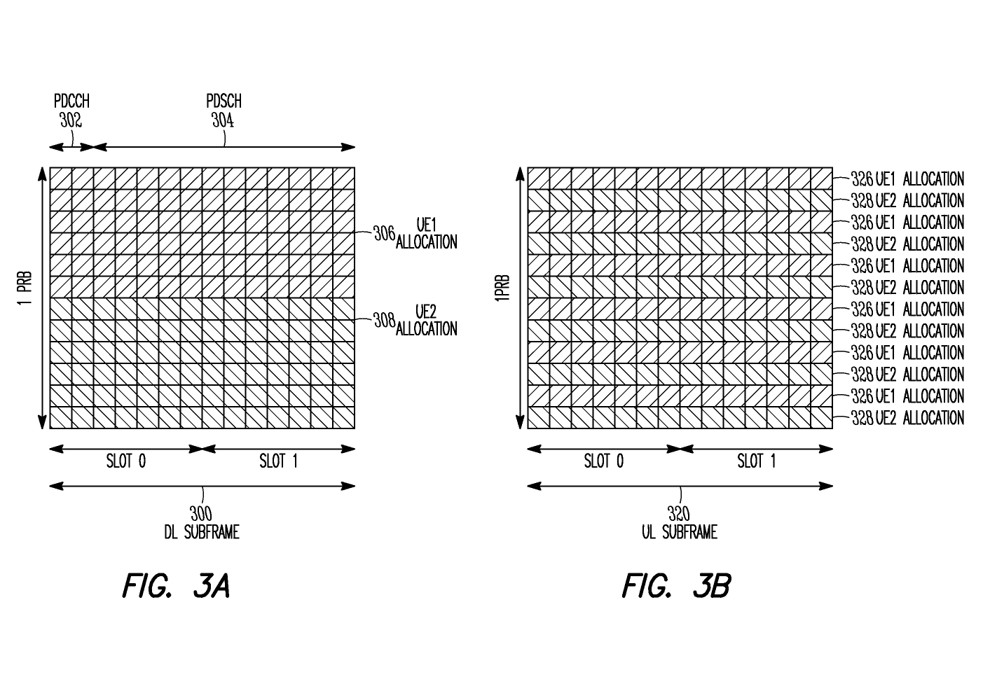

In some embodiments, the resource allocation header may be adjusted to reduce the granularity to PRBₘᵢₙ. In addition, as multiple PRBₘᵢₙ may be allocated within a PRB, the PRBₘᵢₙ of different UEs may be combined in various manners such that the PRBₘᵢₙ of the UEs may be allocated in any of a number of ways. FIGS. 3A and 3B illustrate downlink allocations in a subframe in accordance with some embodiments. In particular, FIGS. 3A and 3B illustrate different embodiments of localized and distributed allocations, respectively. Although not shown, in other embodiments a similar methodology may be applied to uplink communications.

As shown in FIG. 3A, the subframe 300 comprises PDCCH 302 and PDSCH 304 and a localized PRBₘᵢₙ allocation for a first UE 306 and for a second UE 308. As can be seen, the minimum bandwidth granularity may be 6 resource elements, i.e., the granularity may be reduced, for example, to ½PRB of the current PRB. In some embodiments, the PRBₘᵢₙ may be limited in frequency and may be, for example, 90 kHz wide in frequency (6×15 kHz subcarriers or 12×7.5 kHz subcarriers wide) and 1 slot long in time. In other embodiments, the granularity may be different. In some embodiments, the granularity for each UE in the PRB may be the same (i.e., PRBₘᵢₙ is the same), while in other embodiments, the granularity may differ. For example, the PRBₘᵢₙ for two UEs may be ¼ PRB and for a third UE may be ½PRB. The granularities may be set dependent on the type of UE, type of traffic provided by the UE, the time/day, etc. . . . . For localized resource allocation, sets of contiguous subcarriers may be assigned for MTC UEs to transmit and receive the data in the PRBₘᵢₙ. As shown in FIG. 3A, all of the subcarriers assigned to a particular UE may be contiguous. In the example shown in FIG. 3A, UE #1 is assigned subcarrier index {0, 1, 2, 3, 4, 5} while UE #2 is assigned subcarrier index {6, 7, 8, 9, 10, 11}.

FIG. 3B illustrates a subframe 320 having a distributed resource allocation scheme in which the PRBₘᵢₙ is the same as in FIG. 3A. The PRB of the distributed localized allocation scheme provides non-contiguous subcarriers for UE 1 326 and UE 2 328. As can be seen in FIG. 3B, UE 1 is assigned subcarrier index {0, 2, 4, 6, 8, 10} while UE 2 is assigned subcarrier index {1, 3, 5, 7, 9, 11}. Thus, in the example shown, every adjacent subcarrier is assigned to a different UE—the subcarriers alternate assignment in the case of PRBₘᵢₙ=½PRB. In other embodiments, the subcarrier index of one or more of the UEs may contain a combination of localized and distributed resource allocation, i.e., some adjacent subcarriers may be assigned to the same UE while other adjacent subcarriers are assigned to different UEs. In one such example, UE 1 may be assigned subcarrier index {0, 2, 3, 4, 8, 10} while UE 2 is assigned subcarrier index {1, 5, 6, 7, 9, 11}.

In some embodiments, the resource allocation scheme, whether localized or distributed, may be explicitly indicated in the DCI format for DL assignment or UL grant. In some embodiments, the resource allocation scheme may be predefined by the standard or configured via control signaling, such as Radio Resource Control (RRC) signaling when the UE is in an RRC connected mode or in a system information block (SIB). Thus, the resource allocation may be static or dynamically assigned. In some embodiments, if the network determines that the UE is an MTC UE, the signaling overhead may be reduced and the system design simplified by only permitting localized resource allocation within a PRB to be defined for the MTC UE.

The DCI format may be adjusted to enable the DCI format to define a PRBₘᵢₙ having a smaller bandwidth granularity than 1 PRB. For bandwidths of 1.4 MHz, 3 MHz, 5 MHz, 10 MHz, 15, MHz, 20 MHz, the number of PRBs allowed in each band may be, respectively, 6, 15, 25, 50, 75 and 100. Currently, the PRB index and total number of PRBs may be used to indicate which of the above PRBs are to be assigned to the UE. To enable the DCI format to assign the PRBₘᵢₙ, the DCI format may replace the PRB index and total number of PRBs instead respectively with a subcarrier block index and total number of subcarrier blocks. In one example, if the minimum bandwidth granularity is defined as P_{SC}, the number of subcarrier block may be given by B=12/P_{SC} assuming 15 kHz subcarriers. In this case, in the DL resource allocation type 0 and 1, the resource block group size (P) as defined in ETSI TS 136 213 Section 7.1.6.1 may be changed to P*B. Note that in resource allocations of type 0, the resource block assignment information includes a bitmap indicating the resource block groups (consecutive PRBs) that are allocated to a UE, while in resource allocations of type 1 a resource block assignment information of size N_{RBG} indicates to the UE the PRBs from the set of PRBs from one of P resource block group subsets. In resource allocation of type 2, in which the resource block assignment information indicates to the UE a set of contiguously allocated localized or distributed virtual resource blocks, the step value (N_{RB}^{step}) as defined in ETSI TS 136 213 Section 7.1.6.3 may be changed to N_{RB}^{step}·B, where N_{RB}^{step} depends on the downlink system bandwidth.

In some embodiments, additional bits may be provided in the DCI format to indicate the subcarrier indexes within a PRB. In one such embodiment, a bitmap (hereinafter referred to as an individual bitmap) may be used for resource assignment of all subcarriers when the minimum bandwidth granularity permits a resource allocation smaller than 1 PRB. The individual bitmap may indicate whether or not an individual subcarrier within the PRB is assigned. In one embodiment, the individual bitmap may indicate that a particular subcarrier is assigned using a “1” and is not assigned using a “0.” For example, to indicate that the first four subcarriers are assigned to the UE for data transmission, the individual bitmap may specify “111100000000.” The number of additional bits used in the DCI format may thus be equal to the number of subcarriers, which may increase the signaling overhead of the DCI format by an excessive amount.

In some embodiments, a different type of bitmap, hereinafter referred to as a block bitmap, may be used to reduce the amount of signaling overhead. In a block bitmap, instead of individual subcarriers being indicated in the block bitmap as being used to transmit data, blocks of subcarriers may be indicated in the block bitmap as being used to transmit data. The block size may be set by specification, for example, or may be communicated through other types of dynamic control signaling. In some embodiments, the block size may be the minimum bandwidth granularity, while in other embodiments the block size may be larger than the minimum bandwidth granularity but smaller than 1 PRB. For example, assuming that the minimum bandwidth granularity is P_{SC} and the number of subcarrier blocks is 12/P_{SC}, then blocks of subcarriers may be indicated as being used to transmit data using fewer bits. In one embodiment, individual blocks in the block bitmap may indicate that a particular block of subcarriers is assigned for transmission using a “1” and is not assigned using a “0.” For example, if the minimum bandwidth granularity is blocks of four 15 kHz subcarriers, three additional bits may be used to indicate the three blocks forming the PRB. In this case, a block bitmap of “010” may indicate that only the second block is assigned to the UE for transmission. One or more of the blocks may be assigned to a particular UE for transmission. In one specific example of this the first block may indicate the assignment of subcarriers [0, 1, 2, 3], the second block may indicate the assignment of subcarriers [4, 5, 6, 7] and the third block may indicate the assignment of subcarriers [8, 9, 10, 11]. Although in this example, each of the blocks contain consecutive subcarriers, in other embodiments, some or all of the blocks may contain non-consecutive subcarriers. Thus, in another specific example of the first block may indicate the assignment of subcarriers [0, 1, 4, 7], the second block may indicate the assignment of subcarriers [2, 3, 5, 6] and the third block may indicate the assignment of subcarriers [8, 9, 10, 11].

In some embodiments, to further reduce signaling overhead, rather than using an individual bit indicating whether a particular block of subcarriers has been assigned, only a single subcarrier or subcarrier block index may be used in the DCI format for resource assignment. Such an embodiment may save signaling overhead in cases in which greater than two blocks are available to be assigned. In the above example in which three subcarrier blocks are able to be assigned, three values are able to be signaled using two bits. For example, “00,” “01,” and “10” may indicate subcarrier blocks 1, 2 and 3 respectively are assigned. Thus, in this example, rather than “010” indicating that the second subcarrier block only is assigned to the particular UE for transmission using bits of the bitmap to indicate specific blocks, the binary indication “01” may indicate that the second subcarrier block only is assigned to the particular UE for transmission. In other embodiments, any of the four available values may map to the three subcarrier blocks as desired. Each of the extra value(s) may, for example, indicate a specific, predetermined, combination of multiple subcarrier blocks assigned to the particular UE or an alternate arrangement of subcarriers assigned to the particular UE. For example, in the above, assuming the values “00,” “01,” and “10” each indicate a different block of subcarriers that are consistent with each other (i.e., contain non-overlapping subcarriers) is assigned to the UE, the value “11” may be assigned to a block of subcarriers that is not consistent with the other values is assigned to the UE. The eNB may, for example, determine that a UE may be able to communicate more effectively over a particular block of subcarriers (e.g., the block includes only those subcarriers that have less interference) and assign the extra block if no other UEs are to be assigned an inconsistent block of subcarriers. In such an example, for example, UEs may have different priorities such that a high priority UE (or user or transmission) may transmit over such a block while a lower priority UE, whether or not other UEs are present in the cell, is assigned a block containing the consistent set of subcarriers.

In some embodiments, the eNB may signal a list of cell RNTIs (C-RNTIs) in an order for a group of UEs in a manner similar to DCI format 3/3A (which describes transmission of Transmission Control Protocol commands for PUCCH and PUSCH with 2-bit or 1-bit power adjustments). The C-RNTI may thus be a unique identification that signals the UE to which block it is assigned based on the assignment order. Thus, m C-RNTIs may be used for m blocks, each containing n subcarriers. In addition, a common RNTI can be predefined or provided by higher layers for the scrambling of PDCCH such that multiple UEs may be provided with the same common RNTI and the assignment further based on the order of assignment. The higher layer provisioning of the common RNTI may be provided via RRC or SIB signaling. The common RNTI may thus be associated with a resource allocation having a granularity of 1 PRB. In one embodiment, a UE may receive a PDCCH from the eNB using the common RNTI and derive a dedicated subcarrier block dependent on the order of the C-RNTI. Continuing with the above examples, assuming four subcarriers in each block such that there are three blocks in each PRB, the eNB may use three C-RNTIs, signaling, in order, the first UE, the third UE and the second UE. In this case, when the eNB assigns the PRB for this group of UEs, the first UE may be assigned a first block of subcarriers (e.g., subcarriers [0, 1, 2, 3]), the second UE may be assigned a third block of subcarriers (e.g., subcarriers [8, 9, 10, 11]), and the third UE may be assigned a second block of subcarriers (e.g., subcarriers [4, 5, 6, 7]) all within the PRB. As above, the above example is merely exemplary—the blocks may contain contiguous subcarriers and/or non-contiguous subcarriers within the PRB indicated by the common RNTI. Unlike the previous embodiments, using group based scheduling permits the UE and eNB to reuse the DCI format in the existing LTE specification, thereby minimizing the implementation effort.

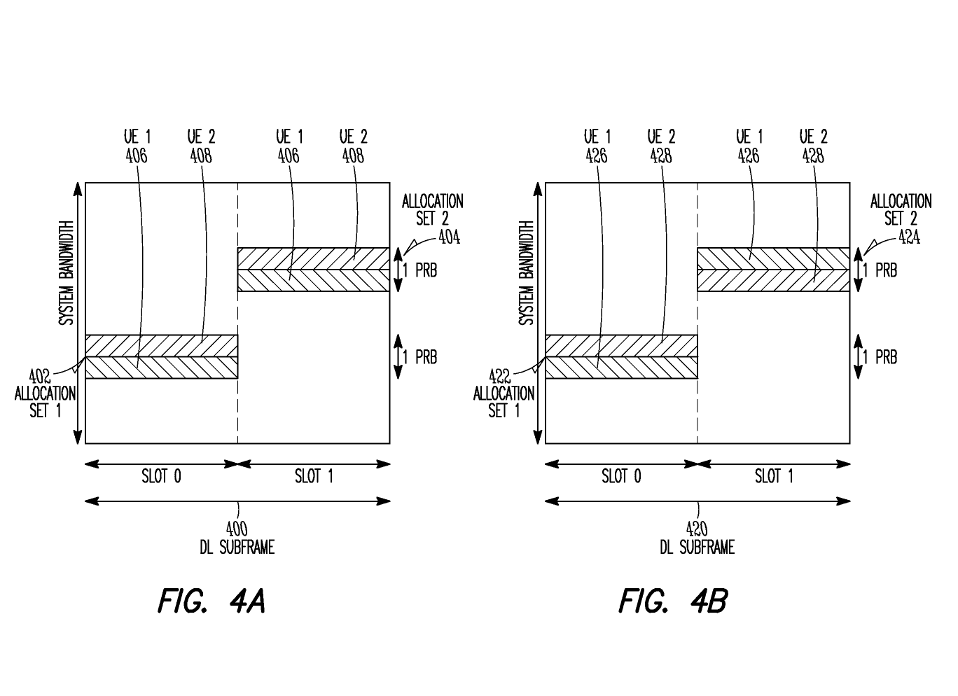

In FIGS. 3A and 3B, different ways in which a PRB may be subdivided to provide allocations of a smaller granularity of a single subframe is shown. While the subframe in FIGS. 3A and 3B illustrate a continuous temporal allocation of resource elements across all slots of each subframe, other embodiments are possible. FIGS. 4A and 4B illustrate downlink allocations in a subframe with frequency hopping in accordance with some embodiments. Similar to the above, although not shown, in other embodiments a similar methodology may be applied to uplink communications. In frequency hopping, the assigned frequency resource allocation may be altered in a controlled manner from one time period to another. Frequency hopping of the UE may be based on explicit frequency hopping information in a scheduling grant from the eNB. The frequency hopping may be inter-subframe hopping or intra-subframe hopping. Intra-subframe hopping may occur between slots, as shown in FIGS. 4A and 4B. A number of different embodiments may be applied to provide frequency hopping.

In one process, the eNB may transmit a scheduling grant to the UE in a DCI message. An uplink scheduling grant in the DCI message may comprise a flag indicating whether frequency hopping is on or off. The UE may receive a scheduling grant with a virtual resource allocation. The virtual resource allocation may then be mapped by the UE to a physical resource allocation in the first slot and to another physical resource allocation in the second slot depending on the frequency hopping type. This is to say that, each distributed type virtual resource block in a subframe may be mapped onto different PRBs, i.e., the same distributed type virtual resource block of two slots may be mapped onto different PRBs, and a gap value may exist between them. Depending on the number of PRBs in the system (system bandwidth), 1 or 2 gap values may be present. The resource allocation signaling from the eNB may indicate the sequence number of a starting virtual resource block and the number of continuous virtual resource blocks.

In one embodiment, the downlink and uplink frequency hopping scheme currently used can be extended to a bandwidth granularity of smaller than 1 PRB. As above, in some embodiments, the PRB index and total number of PRBs may be used to indicate the assignment of resources for communication (whether uplink or downlink) to a particular UE. In a manner similar to the above, when the granularity is reduced, the PRB index and total number of PRBs may be replaced by a subcarrier block index and total number of subcarrier blocks, respectively. Assuming, as above, that the minimum bandwidth granularity is P_{SC} and the number of subcarrier blocks is B=12/P_{SC} (for 15 kHz subcarriers), for distributed type virtual resource blocks, the resource block gap value (N_{gap}) as defined in 3GPP TS 36.211 Section 6.2.3.2 may be adjusted to N_{gap}*B.

In some embodiments, the downlink and uplink frequency hopping scheme having a bandwidth granularity of 1 PRB may be used. In this case, the relative positions of the UE allocation within the 1 PRB may be specified for each frequency hop. To provide frequency hopping, as shown in FIG. 4A in some embodiments, the frequency location within 1 PRB may remain the same as in a localized frequency hopped resource block. For intra-subframe hopping, in slot 0, a first PRB index (e.g., PRB index 3) may be assigned and first subcarrier index (e.g., subcarrier index {0-5}) allocated. With the frequency hopping mechanism, in slot 1, a second PRB index (e.g., PRB index 10) may be obtained as per the existing LTE specification and, within the second PRB, the same subcarrier index (e.g., subcarrier index {0-5}) may be allocated. FIG. 4A illustrates a downlink subframe 402 across the system bandwidth. The subframe 402 may comprise a set of allocations 402, 404 within a PRB. Although only one set of allocations are shown in each slot in FIG. 4A, more may be present across the system bandwidth. In FIG. 4A, each set of allocations 402, 404 contains allocations directed to two UEs (UE1 406 and UE2 408), leading to a minimum bandwidth granularity of 6 subcarriers. Frequency hopping is present in FIG. 4A as the PRBs assigned to UE1 406 and UE2 408 differ between the slots of the subframe 400. Note that MTC UEs may be able to frequency hop as long as the allocations provided by the eNB in different frequency hopping domains are able to be used by the MTC UEs. As may be seen in FIG. 4A, the relative subcarrier locations for allocations among the UE1 406 and UE2 408 within each PRB may remain unchanged between the different frequency hopping domains in the different slots.

In some embodiments, however, the frequency location within 1 PRB may be swapped as in the frequency hopped resource block. In one particular example, if the set of subcarriers within 1 PRBs is defined as Ω, in the hopping resource block, the set of subcarrier may be obtained as 11-Ω. In this case, the data mapping may start from the lowest subcarrier index within the hopped resource block to simplify the design for resource mapping. For example, similar to the above for intra-subframe hopping, in slot 0, a first PRB index (e.g., PRB index 3) may be assigned and first subcarrier index (e.g., subcarrier index {0-5}) allocated. With the frequency hopping mechanism, in slot 1, a second PRB index (e.g., PRB index 10) may be obtained as per the existing LTE specification and, within the second PRB, the same subcarrier index (e.g., subcarrier index {6-11}) may be allocated. The starting subcarrier for data mapping is still subcarrier 6.

FIG. 4B illustrates an example in which the frequency location within 1 PRB differs in a localized frequency hopped resource block. In FIG. 4B, the subframe 422 may comprise a set of allocations 422, 424 within a PRB. As above, although only one set of allocations are shown in each slot in FIG. 4B, more may be present across the system bandwidth. Each set of allocations 422, 424 contains allocations directed to two UEs (UE1 426 and UE2 428), leading to a minimum bandwidth granularity of 6 subcarriers. The PRBs assigned to UE1 426 and UE2 428 differ between the slots of the subframe 420. While both UE1 426 and UE2 428 are allocated within the same PRB, unlike the embodiment shown in FIG. 4A, the relative subcarrier locations allocated among UE1 426 and UE2 428 within each PRB may be swapped between the different frequency hopping domains in the different slots. As above, the frequency hopping mechanism of FIGS. 4A and 4B may be predefined or configured via SIB or RRC signaling. Alternately, the frequency hopping mechanism of FIGS. 4A and 4B may be explicitly signaled in the DCI format for downlink assignment and uplink grant. In some embodiments, to simplify the design, only one frequency hopping mechanism, e.g., that FIG. 4A may be supported.

In some embodiments, the allocation distribution within the PRB of each slot may be independent of each other. This is to say that in both sets of figures: FIGS. 3A and 3B and FIGS. 4A and 4B illustrate embodiments in which the allocation of the PRBs in both UEs are localized such that, in each slot, each subcarrier in the PRB allocated to the UE is adjacent to another subcarrier in the PRB allocated to the UE. In other embodiments, the PRB may be allocated in a distributed manner for both the slots such that each subcarrier in the PRB allocated to the UE is adjacent to only subcarriers in the PRB allocated to one or more different UEs or may be allocated in a mixed fashion with some subcarriers being distributed and some localized. In other embodiments, the PRB may be allocated differently between the slots of a single subframe (or between subframes) such that the allocation for the UE within the PRB of each slot may be localized, distributed or some combination thereof and may be independent of the allocation in the other slot.

The same design principle may be extended and applied for the distributed resource allocation scheme and inter-subframe hopping schemes. The design principle may be extended for downlink frequency hopping for data transmission that is less than 1 PRB. Further, the frequency hopping mechanism may apply for MTC UEs with reduced bandwidth, e.g., 1.4 MHz. The frequency resource may hop within MTC regions as predefined or configured by higher layer signaling. In addition, the frequency hopping may apply to normal UEs with the support of delay tolerant MTC applications. In this case, the frequency resource may hop within the entire system bandwidth. Whether the allocation is localized or distributed, how the UE is provided the allocation and/or whether frequency hopping is present (as well as how frequency hopping is provided) may be dependent on the type of UE, type of traffic provided by the UE, the time/day, and/or other factors.

In modifying communications between the UE and eNB to support a reduced bandwidth of less than 1 PRB, the Demodulation Reference Signal (DM-RS) may also be modified. The DM-RS is a reference signal (also referred to as an LTE pilot signal) that is specific to a particular UE. The DM-RS may be used by the UE for demodulation of a PDSCH and to estimate the channel quality (e.g., the interference from other eNBs). To support a large number of UEs, a large number of DM-RS sequences may be used. Different DM-RS sequences are achieved by cyclic shifts of a base sequence. The UE may take measurements based on the DM-RS and may transmit the measurements to the eNB for analysis and network control. The DM-RS may be transmitted in each resource block allocated to the UE. If the DM-RS is, for some reason, not decoded properly by the eNB, the PUSCH or PUCCH may also not be decoded by the eNB. The DM-RS may be generated using a Zadoff-Chu Sequence as indicated in TS 36.211 section 5.5.1 and may be located in the center symbol of a slot, e.g., symbol 3 (in slot 0) and symbol 10 (in slot 1) of an uplink subframe. To support a large number of UEs, a large number of DM-RS sequences may be generated by using cyclic shifts of a base sequence. In some embodiments, after the DM-RS sequence is generated, the UE may puncture subcarriers not assigned to itself within the PRB.

In some embodiments, as specified in TS 36.211 section 5.5.1 the reference signal sequence r_{u,v}^{(α)}(n) is defined by a cyclic shift α of a base sequence r̅_{u,v}(n) according to

r_{u,v}^{(α)}(n)=e^{jαn} r̅_{u,v}(n), 0≦n<M_{sc}^{RS}

where M_{sc}^{RS}=mN_{sc}^{RB} is the length of the reference signal sequence and 1≦N_{RB}^{max,UL}. Multiple reference signal sequences may be defined from a single base sequence through different values of α. In embodiments in which less than a single resource block may be allocated to a particular UE, m may take values that are different from the above—i.e., 0<m<1, in which case, the DM-RS sequence becomes

r_{u,v}^{(α)}(n)=e^{jαn} r̅_{u,v}(n), n∈Ω

r_{u,v}^{(α)}(n)=0, n∉Ω

where Ω may be a set of the assigned resource elements within one resource block and Ω={0, 1, . . . , 11}.

In some embodiments, the DM-RS sequence may be generated dependent on a base sequence of length less than 12 (1/subcarrier). In this case, for M_{sc}^{RS}=N_{sc}^{sub-RB}, the base sequence may be given by:

r̅_{u,v}(n)=e^{jφ(n)π/4}, 0≦n≦M_{sc}^{RS}−1

where N_{sc}^{sub-RB} is the minimum number of resource elements assigned to one UE. The phase value φ(n) may be generated to have constant modulus in the frequency domain, low CM, low memory/complexity requirements, and good cross-correlation properties. In one embodiment, sequence hopping may be disabled for a sequence length less than 1 resource block, similar to the existing LTE specification for sequence length less than 6 resource blocks. In one example, when N_{sc}^{sub-RB}=6, the phase value φ(n) may be defined as shown in Table 1:

TABLE 1

| | |
|---|---|
| u | φ(0), . . . , φ(5) |

| | | | | | | |
|---|---|---|---|---|---|---|
| 0 | −1 | −1 | 3 | −3 | 3 | −3 |

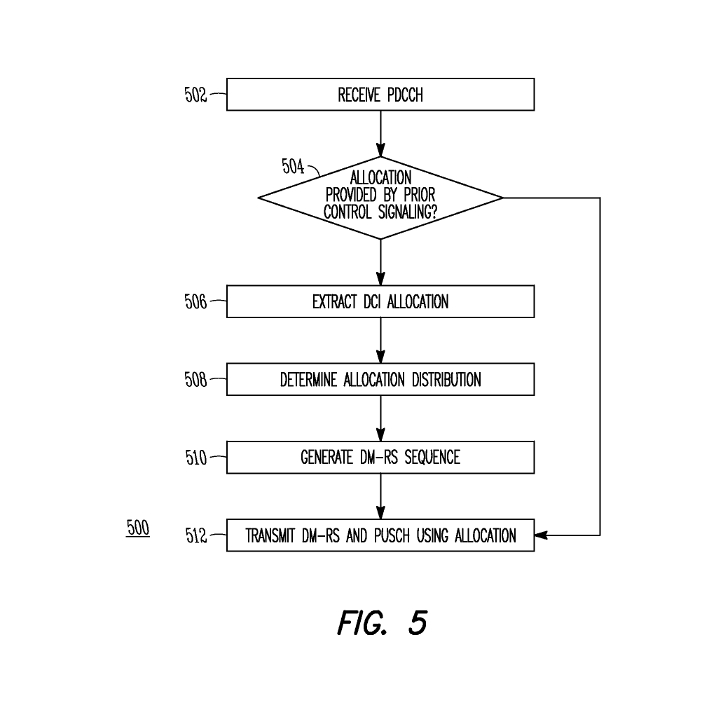

FIG. 5 illustrates a flowchart of a method of employing a reduced data transmission bandwidth in accordance with some embodiments. The method 500 shown in FIG. 5 may be used by, e.g., the UE described in relation to FIG. 2 above. At operation 502 of the method 500, the UE may receive a downlink assignment or uplink grant from the eNB. The assignment or grant may be provided in a PDCCH signal.

At operation 504, the UE may determine whether a resource allocation has been provided by control signaling prior to receiving the PDCCH signal. The resource allocation may be predefined, such as being provided by specification for the system, or configured, e.g. specifically for the UE, via a SIB or RRC signaling. The control signaling may indicate whether the resource allocation is a localized or distributed resource allocation.

If the resource allocation is provided by the PDCCH, at operation 506, the UE may decode the PDCCH and extract the resource allocation from the decoded PDCCH. The PDCCH may contain DCI formats that contain the resource allocation. The UE may be able to determine from the DCI format whether the resource allocation is less than one PRB. For example, the DCI format may comprise a subcarrier block index and total number of subcarrier blocks that specify the resources within the PRB allocated to the UE. In other examples, the DCI format may comprise a bitmap for all subcarriers. In this case, each individual bit of the bitmap may correspond to a unique subcarrier or block of different subcarriers. Alternatively, the bitmap may instead indicate a subcarrier block index whose values correspond to different blocks of subcarriers.

Although not shown, the UE may instead derive the resource allocation using a received C-RNTI associated with an ordered list of C-RNTIs and a common RNTI previously provided to the UE.

At operation 508, the UE may determine the distribution of the resource allocation. The UE may determine that the resource allocation is localized (adjacent subcarriers other than the edge subcarriers are allocated to the UE) or distributed (at least one adjacent subcarrier other than the edge subcarriers is allocated to a different UE). The frequency of the resource allocation as well as the timing of the resource allocation may be determined. For example, the same set of subcarriers may be allocated throughout a subframe, or different sets of subcarriers may be allocated. In the latter case, the resource allocation may include intra-subframe frequency hopping. If the UE determines that the resource allocation includes frequency hopping, the frequency hopping information may be provided by the UE in a scheduling grant and comprise a subcarrier block index and total number of subcarrier blocks. Within a particular PRB, the relative position of the resource allocation for the UE may remain constant or may change.

The UE may also generate at operation 510 a DM-RS sequence. The UE may extract the DM-RS sequence from subcarriers not assigned to the UE in which the DM-RS sequence has been generated by puncturing subcarriers not assigned to the UE. The DM-RS sequence may in addition or instead be generated using a base sequence of a length less than the number of subcarriers in 1 PRB (12).

At operation 512, the UE may transmit DM-RS and information to the eNB using the allocated resources. The UE may transmit during the PUSCH, which may subsequently be received by the eNB. The transmission may use any of the formats described herein, for example including inter or intra-subframe frequency hopping.

Various examples of the disclosure are provided below. These examples are not intended to in any way limit the disclosure herein. In Example 1, a UE comprises a transceiver configured to communicate with an eNB and processing circuitry. The processing circuitry is configured to receive downlink control information (DCI) from the eNB. The DCI is configured to provide a resource allocation comprising a reduced physical resource block (PRBₘᵢₙ) of less than one PRB for at least one of downlink (DL) and uplink (UL) communications in a PRB of a subframe. The PRB comprises 12 wide subcarriers or 24 narrow subcarriers in frequency, and the PRBₘᵢₙ comprises either fewer than 12 wide subcarriers or fewer than 24 narrow subcarriers. The processing circuitry is configured to configure the transceiver to communicate with the eNB using the resource allocation.

In Example 2, the subject matter of Example 1 can optionally include that the resource allocation for the UE within the PRB comprises a localized allocation throughout a slot of the subframe such that each subcarrier in the PRBₘᵢₙ is adjacent to another subcarrier in the PRBₘᵢₙ.

In Example 3, the subject matter of Example 2 can optionally include that the resource allocation for the UE within the PRB comprises a localized allocation throughout both slots of the subframe such that each subcarrier in the PRBₘᵢₙ is adjacent to another subcarrier in the PRBₘᵢₙ throughout the subframe.

In Example 4, the subject matter of one or any combination of Examples 1-3 can optionally include that the resource allocation for the UE within the PRB comprises a distributed allocation throughout a slot of the subframe such that each subcarrier in the PRBₘᵢₙ is adjacent to a subcarrier in another PRBₘᵢₙ, in the PRB, allocated to a different UE.

In Example 5, the subject matter of Example 4 can optionally include that the resource allocation for the UE within the PRB comprises a distributed allocation throughout both slots of the subframe such that each subcarrier in the PRBₘᵢₙ is adjacent to the subcarrier in the other PRBₘᵢₙ throughout the subframe.

In Example 6, the subject matter of one or any combination of Examples 1-5 can optionally include the resource allocation for the UE within the PRBₘᵢₙ throughout a slot of the subframe comprising at least one of a localized allocation throughout a slot of the subframe such that each subcarrier in the PRBₘᵢₙ is adjacent to another subcarrier in the PRBₘᵢₙ and a distributed allocation throughout a slot of the subframe such that each subcarrier in the PRBₘᵢₙ is adjacent to a subcarrier in another PRBₘᵢₙ, in the PRB, allocated to a different UE, and the resource allocations for the UE within the PRB throughout each slot of the subframe are independent of each other.

In Example 7, the subject matter of one or any combination of Examples 1-6 can optionally include that the resource allocation comprises a localized or distributed resource allocation is predefined or configured via a system information block or Radio Resource Control signaling.

In Example 8, the subject matter of one or any combination of Examples 1-7 can optionally include that whether the resource allocation comprises a localized or distributed resource allocation is indicated in the DCI format for a downlink assignment or an uplink grant.

In Example 9, the subject matter of one or any combination of Examples 1-8 can optionally include that the DCI format comprises a subcarrier block index and total number of subcarrier blocks configured to specify the resources within the PRB allocated to the UE.

In Example 10, the subject matter of one or any combination of Examples 1-9 can optionally include that the DCI format comprises a subcarrier bitmap configured to specify the resources within the PRB allocated to the UE, and each individual bit of the subcarrier bitmap corresponds to: a unique one of the subcarriers, or a unique block of subcarriers, each block of subcarriers comprising different subcarriers, or a subcarrier block index whose values correspond to different blocks of subcarriers, each block of subcarriers comprising different sub carriers.

In Example 11, the subject matter of one or any combination of Examples 1-10 can optionally include that the processing circuitry is further configured to: configure the transceiver to receive from the eNB a list of cell RNTIs (C-RNTIs) in an order for a plurality of UEs that comprises the UE, configure the transceiver to receive a first resource allocation with a granularity of 1 PRB dependent on a common RNTI, the common RNTI one of predefined or provided by higher layers for scrambling of a physical downlink control channel, and derive from the first resource allocation a dedicated subcarrier block based on the order of the received C-RNTI to obtain the resource allocation less than 1 PRB.

In Example 12, the subject matter of one or any combination of Examples 1-11 can optionally include that the processing circuitry is further configured to: configure the transceiver to receive from the eNB frequency hopping information in a scheduling grant, the frequency hopping information comprising a subcarrier block index and total number of subcarrier blocks.

In Example 13, the subject matter of one or any combination of Examples 1-12 can optionally include that the processing circuitry is further configured to at least one of: receive a DM-RS sequence generated by puncturing subcarriers not assigned to the UE, and receive a DM-RS sequence generated using a base sequence of length less than 12.

In Example 14, the subject matter of one or any combination of Examples 1-13 can optionally include that the processing circuitry is further configured to: the PRB comprises 6-7 Orthogonal Frequency Division Multiplexing (OFDM) symbols in time, the wider and narrower subcarriers are 15 kHz and 7.5 kHz, respectively, the UE is a Machine Type Communications (MTC) UE restricted to communicate with the eNB over a limited set of subcarriers of a bandwidth spectrum over which the eNB is able to communicate, and the MTC UE is configured to transmit messages of a reduced size over the limited set of subcarriers in uplink transmissions.

In Example 15, the subject matter of one or any combination of Examples 1-14 can optionally include an antenna configured to transmit and receive communications between the transceiver and the eNB.

In Example 16, an apparatus of eNB comprises processing circuitry configured to: configure a transceiver to transmit a downlink control information (DCI) configured to provide a resource allocation in a PRB of a subframe to a plurality of Machine Type Communications user equipments (MTC UEs), the resource allocation for each of the MTC UEs comprising a reduced physical resource block (PRBₘᵢₙ) of less than one PRB for at least one of downlink and uplink communications in the PRB, wherein the PRB comprises 12 wider subcarriers or 24 narrower subcarriers in frequency, the PRBₘᵢₙ comprises fewer than 12 wider subcarriers or fewer than 24 narrower subcarriers, and wherein the eNB is configured to communicate with the MTC UEs using messages of a reduced size over subcarriers of the PRBₘᵢₙ.

In Example 17, the subject matter of Example 16 can optionally include that the resource allocation for each UE within the PRB is one of: a localized allocation throughout a slot of the subframe such that each subcarrier in the PRBₘᵢₙ is adjacent to another subcarrier in the PRBₘᵢₙ, and a distributed allocation throughout a slot of the subframe such that each subcarrier in the PRBₘᵢₙ is adjacent to a subcarrier in another PRBₘᵢₙ, in the PRB, allocated to a different UE of the plurality of UEs, and whether the resource allocation comprises a localized or distributed resource allocation is one of: predefined or configured via a system information block or Radio Resource Control signaling, or indicated in the DCI format.

In Example 18, the subject matter of one or any combination of Examples 16-17 can optionally include that the DCI format comprises a subcarrier bitmap configured to specify the resources within the PRB allocated to the UE, and one of: each individual bit of the subcarrier bitmap corresponds to: a unique one of the subcarriers, or a unique block of subcarriers, each block of subcarriers comprising different subcarriers, or a subcarrier block index whose values correspond to different blocks of subcarriers, each block of subcarriers comprising different sub carriers.

In Example 19, the subject matter of one or any combination of Examples 16-18 can optionally include that the processing circuitry is configured to: configure the transceiver to transmit to the UEs a list of cell RNTIs (C-RNTIs) in an order for the UEs, and configure the transceiver to transmit a first resource allocation with a granularity of 1 PRB dependent on a common RNTI to the UEs, the common RNTI one of predefined or provided by higher layers for scrambling of a physical downlink control channel, wherein a dedicated subcarrier block is derivable by the UEs from the first resource allocation based on the order of the received C-RNTI to obtain the resource allocation less than 1 PRB.

In Example 20, the subject matter of one or any combination of Examples 16-19 can optionally include that the processing circuitry is configured to: configure the transceiver to transmit to the UEs frequency hopping information in a scheduling grant, and one of: the frequency hopping information comprises a subcarrier block index and total number of subcarrier blocks, and wherein whether a relative position of the resource allocation for each UE within the PRB between slots of the subframe remains the same or differs between the slots is one of: predefined or configured via a system information block or Radio Resource Control signaling, or indicated in the DCI format.

In Example 21, the subject matter of one or any combination of Examples 16-20 can optionally include the transceiver, the transceiver configured to transmit signals through a network and receive signals from the UE.

In Example 22, a non-transitory computer-readable storage medium is disclosed that stores instructions for execution by one or more processors of a user equipment (UE) to configure the UE to communicate with an enhanced NodeB (eNB), the one or more processors to configure the UE to: receive downlink control information (DCI) from the eNB, the DCI configured to provide a localized or distributed resource allocation comprising a reduced physical resource block (PRBₘᵢₙ) of less than 1 PRB for at least one of downlink (DL) and uplink (UL) communications in a PRB of a subframe, wherein the PRB comprises 6-7 Orthogonal Frequency Division Multiplexing (OFDM) symbols in time and 12 15 kHz subcarriers or 24 7.5 kHz subcarriers in frequency, wherein the PRBₘᵢₙ comprises fewer than 12 15 kHz subcarriers or fewer than 24 7.5 kHz subcarriers, and wherein whether the resource allocation comprises a localized or distributed resource allocation is indicated in the DCI format.

In Example 23, the subject matter of Example 22 can optionally include that the DCI format comprises a subcarrier block index and total number of subcarrier blocks configured to specify the resources within the PRB allocated to the UE, or the DCI format comprises a bitmap for all subcarriers in which one of: each individual bit of the bitmap corresponds to a unique block of subcarriers, each block of subcarriers comprising different subcarriers, the bitmap configured to specify the resources within the PRB allocated to the UE, or a subcarrier block index whose values correspond to different blocks of subcarriers, each block of subcarriers comprising different subcarriers, the bitmap configured to specify the resources within the PRB allocated to the UE.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, UE, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. User equipment (UE) comprising:
a transceiver configured to transmit signals to and receive signals from an enhanced Node B (eNB) in a network; and
processing circuitry configured to:
receive downlink control information (DCI) from the eNB, the DCI configured to provide a resource allocation comprising a reduced physical resource block (PRBₘᵢₙ) of less than one PRB for at least one of downlink (DL) and uplink (UL) communications in a PRB of a subframe, wherein the PRB comprises 12 wide subcarriers or 24 narrow subcarriers in frequency, and wherein the PRBₘᵢₙ comprises either fewer than 12 wide subcarriers or fewer than 24 narrow subcarriers; and
configure the transceiver to communicate with the eNB using the resource allocation.

2. The UE of claim 1, wherein:
the resource allocation for the UE within the PRB comprises a localized allocation throughout a slot of the subframe such that each subcarrier in the PRBₘᵢₙ is adjacent to another subcarrier in the PRBₘᵢₙ.

3. The UE of claim 2, wherein:
the resource allocation for the UE within the PRB comprises a localized allocation throughout both slots of the subframe such that each subcarrier in the PRBₘᵢₙ is adjacent to another subcarrier in the PRBₘᵢₙ throughout the subframe.

4. The UE of claim 1, wherein:
the resource allocation for the UE within the PRB comprises a distributed allocation throughout a slot of the subframe such that each subcarrier in the PRBₘᵢₙ is adjacent to a subcarrier in another PRBₘᵢₙ, in the PRB, allocated to a different UE.

5. The UE of claim 4, wherein:
the resource allocation for the UE within the PRB comprises a distributed allocation throughout both slots of the subframe such that each subcarrier in the PRBₘᵢₙ is adjacent to the subcarrier in the other PRBₘᵢₙ throughout the subframe.

6. The UE of claim 1, wherein:
the resource allocation for the UE within the PRBₘᵢₙ throughout a slot of the subframe comprises at least one of a localized allocation throughout a slot of the subframe such that each subcarrier in the PRBₘᵢₙ is adjacent to another subcarrier in the PRBₘᵢₙ and a distributed allocation throughout a slot of the subframe such that each subcarrier in the PRBₘᵢₙ is adjacent to a subcarrier in another PRBₘᵢₙ, in the PRB, allocated to a different UE, and
the resource allocations for the UE within the PRB throughout each slot of the subframe are independent of each other.

7. The UE of claim 1, wherein:
whether the resource allocation comprises a localized or distributed resource allocation is predefined or configured via a system information block or Radio Resource Control signaling.

8. The UE of claim 1, wherein:
whether the resource allocation comprises a localized or distributed resource allocation is indicated in the DCI format for a downlink assignment or an uplink grant.

9. The UE of claim 1, wherein:
the DCI format comprises a subcarrier block index and total number of subcarrier blocks configured to specify the resources within the PRB allocated to the UE.

10. The UE of claim 1, wherein:
the DCI format comprises a subcarrier bitmap configured to specify the resources within the PRB allocated to the UE, and one of:
each individual bit of the subcarrier bitmap corresponds to:
a unique one of the subcarriers, or
a unique block of subcarriers, each block of subcarriers comprising different subcarriers, or
a subcarrier block index whose values correspond to different blocks of subcarriers, each block of subcarriers comprising different subcarriers.

11. The UE of claim 1, wherein the processing circuitry is further configured to:
configure the transceiver to receive from the eNB a list of cell RNTIs (C-RNTIs) in an order for a plurality of UEs that comprises the UE,
configure the transceiver to receive a first resource allocation with a granularity of 1 PRB dependent on a common RNTI, the common RNTI one of predefined or provided by higher layers for scrambling of a physical downlink control channel, and
derive from the first resource allocation a dedicated subcarrier block based on the order of the received C-RNTI to obtain the resource allocation less than 1 PRB.

12. The UE of claim 1, wherein the processing circuitry is further configured to:
configure the transceiver to receive from the eNB frequency hopping information in a scheduling grant, the frequency hopping information comprising a subcarrier block index and total number of subcarrier blocks.

13. The UE of claim 1, wherein the processing circuitry is further configured to at least one of:
receive a DM-RS sequence generated by puncturing subcarriers not assigned to the UE, and
receive a DM-RS sequence generated using a base sequence of length less than 12.

14. The UE of claim 1, wherein:
the PRB comprises 6-7 Orthogonal Frequency Division Multiplexing (OFDM) symbols in time,
the wider and narrower subcarriers are 15 kHz and 7.5 kHz, respectively,
the UE is a Machine Type Communications (MTC) UE restricted to communicate with the eNB over a limited set of subcarriers of a bandwidth spectrum over which the eNB is able to communicate, and
the MTC UE is configured to transmit messages of a reduced size over the limited set of subcarriers in uplink transmissions.

15. The UE of claim 1, further comprising an antenna configured to transmit and receive communications between the transceiver and the eNB.

16. An apparatus of an eNode B (eNB), the apparatus comprising:
processing circuitry configured to:
configure a transceiver to transmit a downlink control information (DCI) configured to provide a resource allocation in a PRB of a subframe to a plurality of Machine Type Communications user equipments (MTC UEs), the resource allocation for each of the MTC UEs comprising a reduced physical resource block (PRBₘᵢₙ) of less than one PRB for at least one of downlink and uplink communications in the PRB, wherein the PRB comprises 12 wider subcarriers or 24 narrower subcarriers in frequency, the PRBₘᵢₙ comprises fewer than 12 wider subcarriers or fewer than 24 narrower subcarriers, and
wherein the eNB is configured to communicate with the MTC UEs using messages of a reduced size over subcarriers of the PRBₘᵢₙ.

17. The apparatus of claim 16, wherein at least one of:
the resource allocation for each UE within the PRB is one of:
a localized allocation throughout a slot of the subframe such that each subcarrier in the PRBₘᵢₙ is adjacent to another subcarrier in the PRBₘᵢₙ, and
a distributed allocation throughout a slot of the subframe such that each subcarrier in the PRBₘᵢₙ is adjacent to a subcarrier in another PRBₘᵢₙ, in the PRB, allocated to a different UE of the plurality of UEs, and
whether the resource allocation comprises a localized or distributed resource allocation is one of:
predefined or configured via a system information block or Radio Resource Control signaling, or
indicated in the DCI format.

18. The apparatus of claim 16, wherein:
the DCI format comprises a subcarrier bitmap configured to specify the resources within the PRB allocated to the UE, and one of:
each individual bit of the subcarrier bitmap corresponds to:
a unique one of the subcarriers, or
a unique block of subcarriers, each block of subcarriers comprising different subcarriers, or
a subcarrier block index whose values correspond to different blocks of subcarriers, each block of subcarriers comprising different subcarriers.

19. The apparatus of claim 16, wherein the processing circuitry is further configured to:
configure the transceiver to transmit to the UEs a list of cell RNTIs (C-RNTIs) in an order for the UEs, and
configure the transceiver to transmit a first resource allocation with a granularity of 1 PRB dependent on a common RNTI to the UEs, the common RNTI one of predefined or provided by higher layers for scrambling of a physical downlink control channel,
wherein a dedicated subcarrier block is derivable by the UEs from the first resource allocation based on the order of the received C-RNTI to obtain the resource allocation less than 1 PRB.

20. The apparatus of claim 16, wherein the processing circuitry is further configured to:
configure the transceiver to transmit to the UEs frequency hopping information in a scheduling grant, and
one of:
the frequency hopping information comprises a subcarrier block index and total number of subcarrier blocks, and
wherein whether a relative position of the resource allocation for each UE within the PRB between slots of the subframe remains the same or differs between the slots is one of:
predefined or configured via a system information block or Radio Resource Control signaling, or
indicated in the DCI format.

21. The apparatus of claim 16, further comprising the transceiver, the transceiver configured to transmit signals through a network and receive signals from the UE.

22. A non-transitory computer-readable storage medium that stores instructions for execution by one or more processors of a user equipment (UE) to configure the UE to communicate with an enhanced NodeB (eNB), the one or more processors to configure the UE to:
receive downlink control information (DCI) from the eNB, the DCI configured to provide a localized or distributed resource allocation comprising a reduced physical resource block (PRBₘᵢₙ) of less than 1 PRB for at least one of downlink (DL) and uplink (UL) communications in a PRB of a subframe,
wherein the PRB comprises 6-7 Orthogonal Frequency Division Multiplexing (OFDM) symbols in time and 12 15 kHz subcarriers or 24 7.5 kHz subcarriers in frequency,
wherein the PRBₘᵢₙ comprises fewer than 12 15 kHz subcarriers or fewer than 24 7.5 kHz subcarriers, and
wherein whether the resource allocation comprises a localized or distributed resource allocation is indicated in the DCI format.

23. The non-transitory computer-readable storage medium of claim 22, wherein:
the DCI format comprises a subcarrier block index and total number of subcarrier blocks configured to specify the resources within the PRB allocated to the UE, or
the DCI format comprises a bitmap for all subcarriers in which one of:
each individual bit of the bitmap corresponds to a unique block of subcarriers, each block of subcarriers comprising different subcarriers, the bitmap configured to specify the resources within the PRB allocated to the UE, or
a subcarrier block index whose values correspond to different blocks of subcarriers, each block of subcarriers comprising different subcarriers, the bitmap configured to specify the resources within the PRB allocated to the UE.
